(19) United States
(12) Patent Application Publication
(10) Pub. No.: US 2019/0105951 A1
(43) Pub. Date: Apr. 11, 2019

(54) OVER-TIRE COVER INCORPORATING BOLT-LIKE STUDS AND TREADS OF DIFFERENT SHAPES AND SIZES, WHICH COVER EASILY FITS OVER TIRES FOR WHEELCHAIRS, BICYCLES AND THE LIKE TO PROVIDE MORE TRACTION, SAFETY AND SECURITY WHEN ROLLING OVER VARIOUS OUTDOOR SURFACES, WHICH COVER MAY AFTER USE BE EASILY SLIPPED OFF

(71) Applicant: Wali Brown, Flanders, NJ (US)

(72) Inventor: Wali Brown, Flanders, NJ (US)

(21) Appl. No.: 15/726,571

(22) Filed: Oct. 6, 2017

(51) Int. Cl. B60C 11/16; B60C 11/00

(52) U.S. Cl. CPC B60C 11/1637; A61G 5/10; B60C 11/00

(57) ABSTRACT

An new and improved apparatus is described that provides more secure wheeling for wheelchairs, bicycles and similar vehicles, consisting of an elastomeric over-tire cover which may be secured to a tire, which cover contains treads of various suitable sizes and shapes and bolt-like studs distributed around the outside circumference of said cover, which cover may be easily removed when no longer needed, such as when using a wheeled conveyance indoors.

This application claims priority of U.S. Provisional patent application No. 62/507,954 filed May 18, 2017.

### FIELD OF THE INVENTION

The present invention relates to the tires of wheelchairs, bicycles and similar means of transport. More particularly, this invention relates to rubber tire covers that fit easily over the tires and are secured thereto to provide for more traction and security when the user is rolling over various types of challenging outdoor surfaces, and are also easily removed when the user moves indoors.

### BACKGROUND OF THE INVENTION

People confined to wheelchairs may feel limited in their mobility when confronted with outdoor surfaces, especially when these surfaces become wet, snowy or icy. Leaving paved surfaces to roll over dirt, gravel or rocky uneven surfaces may present dangers and can be extremely challenging. The same challenges can face bicyclists and even people wheeling strollers and similar vehicles. Automobile tires are well known that incorporate studs or may be equipped with chains in the event of bad weather, but these features are often prohibited because of damage caused to public roads. These features are not available for wheelchairs, bicycles of similar vehicles.

An improved apparatus is needed that provides more secure wheeling for wheelchairs, bicycles and similar vehicles consisting of an elastomeric cover which may be secured to a tire, which cover contains treads of various suitable sizes and bolt-like studs distributed around the outside circumference of said cover. Said cover is designed to be easily removed after use, when the vehicle is brought indoors.

### SUMMARY OF THE INVENTION

It is therefore an object of the present invention to provide a new and improved apparatus that provides more secure wheeling for wheelchairs, bicycles and similar vehicles, that consists of an elastomeric over-tire cover which may be secured to a tire, which cover contains treads of various suitable sizes and bolt-like studs of various designs which may be distributed around the outside circumference of said cover.

It is a further object of the present invention to provide a new and improved apparatus that provides more secure wheeling for wheelchairs, bicycles and similar vehicles consisting of an elastomeric over-tire cover which may be secured to a tire, which cover contains treads of various suitable sizes and bolt-like studs distributed around the outside circumference of said cover, which cover may be easily removed when no longer needed, such as when coming indoors.

It is a further object of the present invention to provide a new and improved apparatus that provides more secure wheeling for wheelchairs, bicycles and similar vehicles consisting of an elastomeric cover which may be secured to a tire, which cover contains treads of various suitable sizes and bolt-like studs distributed around the outside circumference of said cover, which cover gives the user confidence and an efficient experience while rolling.

It is a further object of the present invention to provide a new and improved apparatus that provides more secure wheeling for wheelchairs, bicycles and similar vehicles consisting of an elastomeric cover which may be secured to a tire, which cover contains treads of various suitable sizes and bolt-like studs distributed around the outside circumference of said cover, providing the user with the equivalent of off-road and all-weather tires.

It is a further object of the present invention to provide a new and improved apparatus that provides more secure wheeling for wheelchairs, bicycles and similar vehicles consisting of an elastomeric cover which may be secured to a tire, which cover contains treads of various suitable sizes and bolt-like studs distributed around the outside circumference of said cover, reducing slipping in order to provide the user with a feeling of added safety and protection.

It is a further object of the present invention to provide new and improved apparatus that provides more secure wheeling for wheelchairs, bicycles and similar vehicles consisting of an elastomeric cover which may be secured to a tire, which cover contains treads of various suitable sizes and bolt-like studs distributed around the outside circumference of said cover, which may be used with any such vehicle that may be driven, rolled, pushed, ridden or pedaled.

These and other features of the invention can be further understood by reference to the following drawings.

### BRIEF DESCRIPTION OF THE DRAWINGS

FIG. 1 is a front view of the over-tire cover before application to a tire showing one embodiment with treads and bolt-like studs according to the present invention.

FIG. 2 is an elevation view of the over-tire cover after application to a wheelchair tire, showing one embodiment of the present invention with treads and bolt-like studs.

FIG. 3 is an elevation view of the over-tire cover before application to a tire showing one embodiment of the present invention with treads and bolt-like studs and one of the straps used to apply the over-tire cover to a tire.

FIG. 4 is an elevation view of the over-tire cover before application to a wheelchair tire, showing another embodiment with different bolt-like studs.

### DETAILED DESCRIPTION OF THE INVENTION

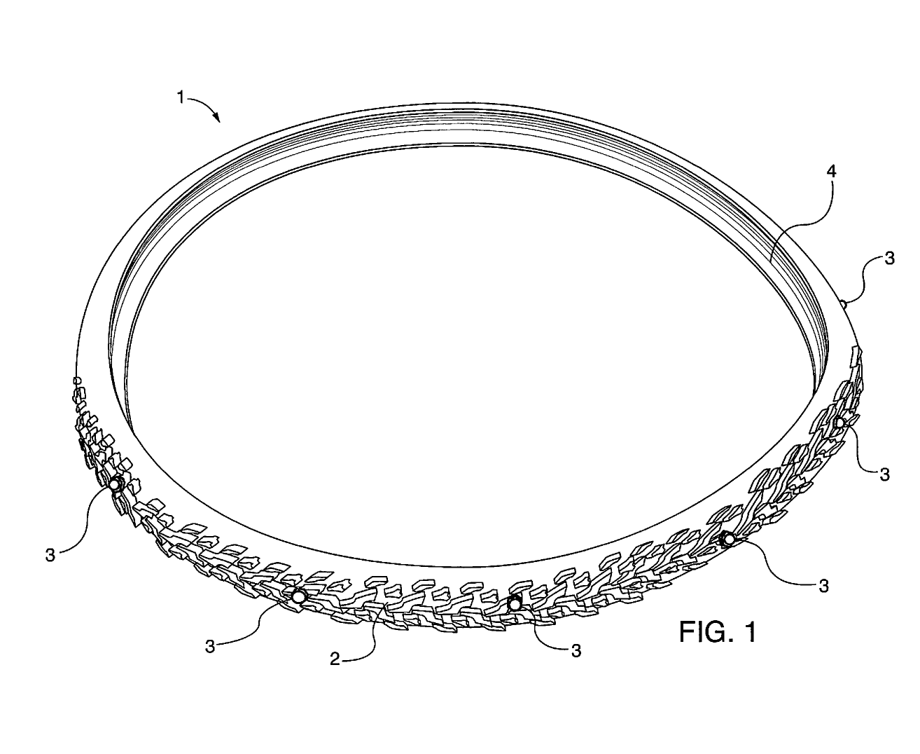

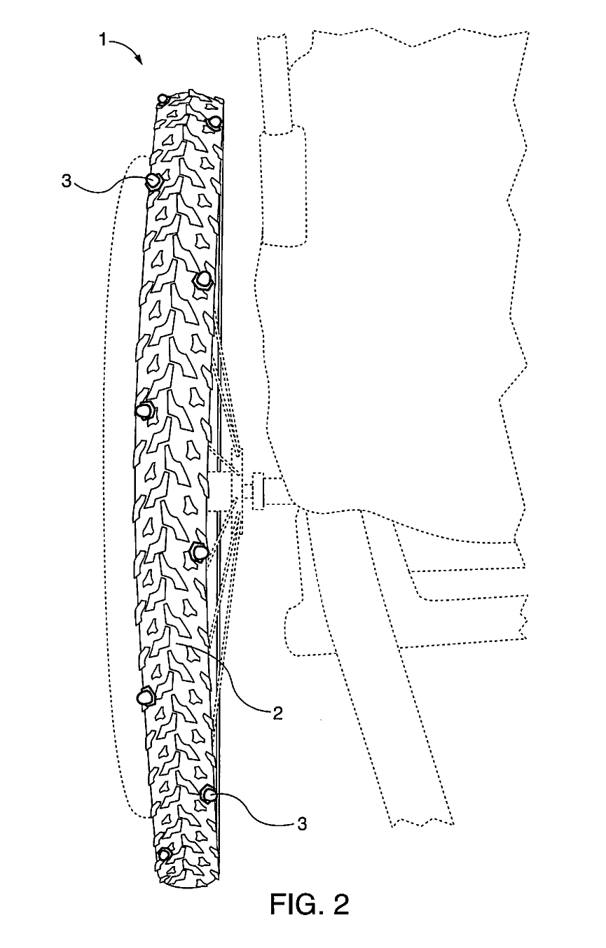

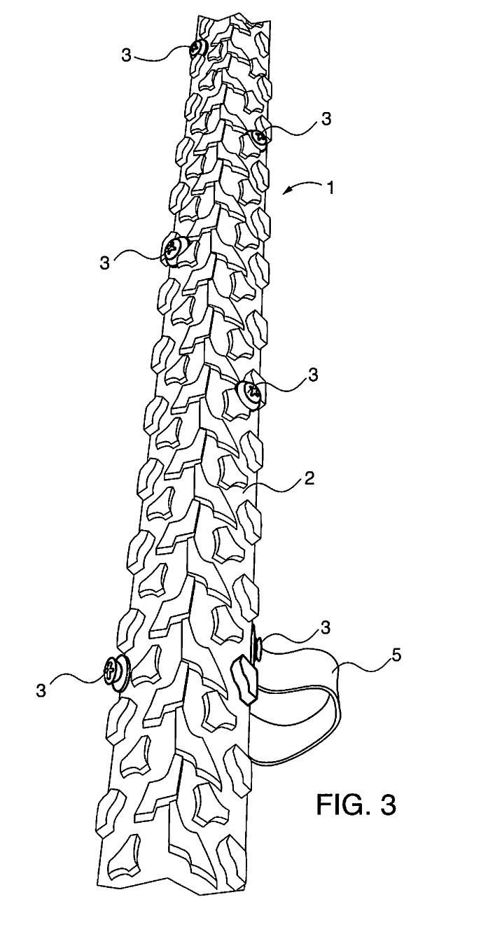

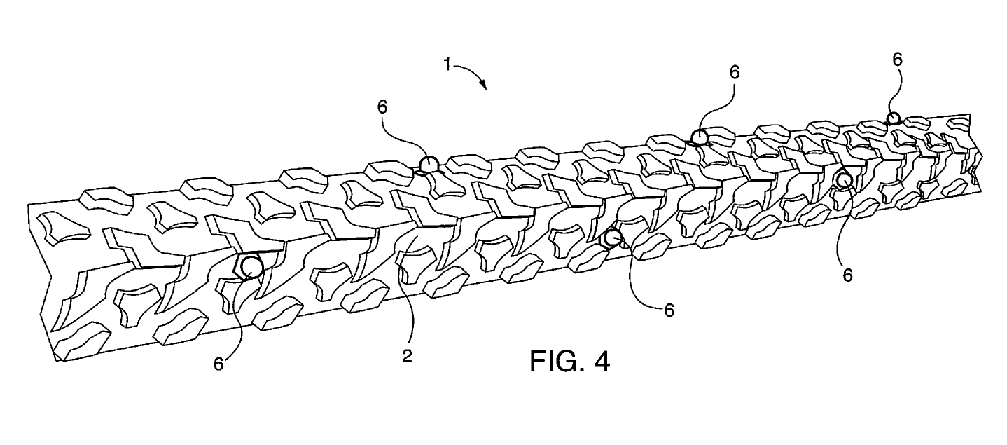

Reference will now be made in detail to an over-tire cover 1 of the present invention with reference to the attached drawings. FIG. 1 is a front view of the over-tire cover before application to a tire showing one embodiment with treads and bolt-like studs 3 and 6 according to the present invention. FIG. 2 is an elevation view of the over-tire cover after application to a wheelchair tire, showing one embodiment of the present invention with treads and bolt-like studs. FIG. 3 is an elevation view of the over-tire cover before application to a tire showing one embodiment of the present invention with treads and bolt-like studs and one of the straps used to apply the over-tire cover to a tire. FIG. 4 is an elevation view of the over-tire cover before application to a wheelchair tire, showing another embodiment with different bolt-like studs.

The over-tire cover 1 includes a tread pattern 2, which preferentially is symmetrical about an equatorial centerline. Said tread pattern 2 results from various patterns of ribs and grooves which provide enhanced traction when wheeling over a multitude of surfaces.

The over-tire cover 1 also includes bolt-like studs 3 and 5 having various designs which provide enhanced traction when wheeling over a multitude of surfaces.

The over-tire cover 1 may be applied to a tire on a bicycle, wheelchair or the like by stretching said over-tire cover over said tire as shown in FIG. 2, with the inner surface 4 of said over-tire cover in contact with the outside surface of the selected tire. Said over-tire cover 1 is secured to the tire beneath by means of straps, 5. By reversing the application process the over-tire cover may be easily removed from the tire beneath.

It is to be understood that variations and modifications of the present invention may be made without departing from the scope thereof. It is also to be understood that the present invention is not to be limited by the specific embodiments disclosed herein, but only in accordance with the appended claims when read in light of the foregoing specification.

What is claimed is:

1. An over-tire cover comprising:
a flexible elastomeric tire including an outer annular portion, said outer annular portion having a tread pattern of ribs and grooves, preferentially symmetrical about an equatorial centerline, and a plurality of bolt-like studs affixed to said annular portion;
an annular rim formed of flexible elastomeric material, said annular rim including an inner area of the outer annular portion and a plurality of bolt-like studs extending through said annular rim through the outer annular portion.
